(19) United States
(12) Patent Application Publication
(10) Pub. No.: US 2020/0343578 A1
(43) Pub. Date: Oct. 29, 2020

(54) Alkali-Ion Battery Based on Selected Allotropes of Sulphur, and Methods for the Production Thereof

(71) Applicants: Sebastian Oberwalder, London (GB); Iontech Systems AG, Heerbrugg (CH)

(72) Inventors: Sebastian Oberwalder, London (GB); Werner Lautenschläger, Heerbrugg (CH); Jens Lautenschläger, Heerbrugg (CH); Marek Slavik, Sered (SK)

(21) Appl. No.: 16/758,540

(22) PCT Filed: Oct. 19, 2018
(86) PCT No.: PCT/EP2018/078703

§ 371 Date: Apr. 23, 2020

(30) Foreign Application Priority Data
Oct. 23, 2017 (DE) 10 2017 010 031.4

(51) Int. Cl. H01M 10/058; H01M 10/052; H01M 10/054; H01M 10/0562; H01M 4/1397

(52) U.S. Cl. CPC H01M 10/058; H01M 10/052; H01M 2004/029; H01M 10/0562; H01M 4/1397; H01M 10/054

(57) ABSTRACT

The invention relates to a new generation of alkali-ion-sulphur batteries in which specific sulphur allotropes, particularly the Psi allotrope of sulphur, are used as the active material of the cathode. Alkali metals or alkaline-earth metals are used as anodes. A preferred production method describes the production of the Psi-sulphur fibres by a special form of electrospinning. Another preferred production method describes the addition of the cation source in liquid form during the production of battery stacks. Finally, the invention relates to specific preferred novel forms of embodiment of alkali-ion-sulphur batteries, which are characterised by significant advantages in terms of capacity and service life.

In the prior art, alkali metal-sulfur batteries consist of a negative electrode (anode) formed by an alkali metal or alkaline earth metal source, preferably composed of metallic lithium, and a positive electrode (cathode) formed by thermodynamically stable orthorhombic sulfur S₈ (=the alpha-allotrope of sulfur).

The sulfur cathode is preferably produced using a slurry coating method in the prior art. Here, the sulfur material is typically milled in the first step (1) and mixed with electrically conductive materials. These are present in various material forms and particle structures, in particular in (a) spherical carbon particles and metal oxide particles (without any particular orientation, also referred to as OD structures); (b) one-dimensional materials (ii) structures) such as e.g. fibers, hollow fibers, rods and tubes; (c) two-dimensional materials (2D structures) such as e.g. graphene and graphene derivatives or carbon-free 2D structures such as boron nitride (in particular hexagonal, h-BN) which are thermally or chemically treated to allow incorporation of sulfur into the electrode structure. These materials are typically once again milled and/or mixed with one or more of the following substances: solvents, binders, shaping or shape-changing additives and also further conductive materials in a second step (2) in order to obtain a suspension (slurry) which is subsequently applied to both sides of collector foils. These foils are then dried, pressed and rolled (calendered) in order to obtain a continuous cathode composite foil from which the final electrode shape is obtained by appropriate cutting to size, preferably by stamping, ablation or laser cutting processes. The foils obtained here have to have clean and (largely) defect-free surfaces. These cathode electrodes are then installed in the final cathode-separator-anode cell. The electrode arrangement here is generally monopolar. An electrolyte is then usually injected into the finished cells which are then finally formatted.

Thus, the production process for lithium-sulfur cells in the prior art consists of one, more than one or typically all of the following steps: production of a suspension, coating, drying of the electrode, calendering, cutting to size, quality control, assembly of the cells, injection of the electrolyte, formatting. All these process steps are, both individually and in total, time-consuming, difficult to carry out, susceptible to errors and thus require error tolerances in production. This firstly makes the process steps (and as a result also the batteries produced) expensive, and secondly the batteries obtained have fewer charging cycles, longer charging times, decreased safety and a significantly lower capacity than is predicted theoretically.

The present invention now provides inventive solutions for most of these unmatured design properties and error-prone process steps. The invention likewise provides superior material configurations of the active cathode composition. This results in more advantageous, more reliable and simpler-to-produce battery types having superior (shorter) charging times, higher operational reliability and significantly higher capacity than known sulfur-alkali metal batteries. Sulfur is the element having the greatest known number of solid allotropes (see, for example, Steudel R., Eckert B., “Solid Sulfur Allotropes” in: Steudel R. (editor) “Elemental Sulfur and Sulfur-Rich Compounds I.”, Topics in Current Chemistry 2003, vol. 230, p. 1-79, Springer, Berlin, Heidelberg). Nevertheless, the entire research and development in respect of batteries has hitherto focused only on orthorhombic alpha (α) sulfur (S₈), the most widely occurring form of sulfur. Sulfur (like selenium and tellurium) is subject to a gradual pressure-induced structural phase transition and also a transition from insulator to conductor. Utilization of this phase transition for producing superior types of batteries is claimed here.

At room temperature (25° C.) and atmospheric pressure (˜1000 hPa), sulfur is present as the orthorhombic cycloocta. variant (S₈). As the pressure or shear force increases and/or the temperature increases, sulfur transforms into more or less stable further allotropes. The invention relates to the use of allotropes having a chain-like arrangement, in particular those which also have an increased conductivity or a transition in the conductivity from de facto insulating to conductive or semiconductive in industrial terms. For this reason, all sulfur variants which form fibers and/or polymeric sulfur chains (sometimes also referred to as “concatenated” in the literature) and consist of linear but not necessarily straight arrangements of sulfur atoms, regardless of whether they contain other substances as impurities and/or have secondary branching and/or branches, are claimed. In the present invention, preference is given to, in each case individually or in combination, the use of the phi (ϕ), mu (μ), omega (Ω) or Psi (Ψ) allotropes of sulfur, particularly preferably the psi allotrope of sulfur.

In general, the chain-like homopolymers of sulfur have chain lengths n of from about 100 to about 10 000 sulfur atoms. Here, the average chain length of psi-sulfur (n=100 to 200) increases via omega-sulfur and phi-sulfur up to gamma-sulfur (n up to 10 000). The sulfur chains in psi-sulfur are linear, while the chains in phi-sulfur and omega-sulfur have a helical structure. The chains of polymeric gamma-sulfur, which have a length of up to 10 000 sulfur atoms, have no preferred structure and can, for example, have regions having a helical structure. The structure of the allotropes can be confirmed by X-ray structure analysis (XRD analysis) (see, for example, S. Geller, M. D. Lind “Indexing of the Ψ-sulfur fiber pattern” in Acta Crystallographica B25 (October 1969), p. 2166-2167).

For the purposes of the present invention, the particularly preferred psi-sulfur consists of linear chains of sulfur atoms which are straight (“stretched”), i.e. are not helical or otherwise curved. The average chain length n is here from 100 to 200 atoms.

The concentration of the allotropes claimed, in each case individually or together, in the active part of the cathode is preferably from 5 to 95%, more preferably from 60 to 90%, very particularly preferably from 73 to 77%. Sulfur materials in which the sulfur chains and/or allotropes described are present in a greater amount than would occur randomly or in general naturally are expressly claimed.

The use of a mixture of psi, phi and gamma (γ) allotropes of sulfur, with or without other minor impurities, is likewise preferred. The use of the phi allotrope, both as right-handed or left-handed helix phase, not exclusively an impurity or precursor substance but also as independent material stabilizer is preferred and claimed. As such, it is an independent component, but not necessarily constituent, and can thus be used either in combination with the psi allotrope or else independently thereof. The preferred proportion by mass of phi-sulfur allotropes is 5-30%, more preferably 10-15%, most preferably 12%. The preferred concentration of the other allotropes claimed remains unaltered thereby, for example particularly preferably: 12% of phi allotrope, 60% of psi allotrope and 3% of mu, gamma and omega allotropes.

(All figures are +/− industrially normal production—and/or measurement-related standard deviations, all percentages are percent by mass (m/m)),

The abovementioned polymeric sulfur allotropes (psi, phi, mu, omega, gamma) can be used in pure form or in the mixtures indicated.

Preference is given to a mixture of linear chains of psi-sulfur with helical chains of phi-sulfur and/or omega-sulfur and/or gamma-sulfur.

In such mixtures, one or more of the linear chains of psi-sulfur are particularly preferably enclosed in a helix of phi-, omega- or gamma-sulfur. In this way, a back-transformation of psi-sulfur into helical or orthorhombic allotropes is suppressed. The combination has a high stability and the significantly better conductivity of psi-sulfur is stabilized.

According to the invention, the use of the claimed psi and/or phi allotropes of sulfur as active cathode material is effected in the form of ID sulfur structures, preferably (nano)fibers or rods. Further preference is given to the fibers being present as hollow fibers composed of sulfur (phi and/or omega; or gamma), which leads to internal stabilization of shorter sulfur chain structures (psi) within these (nano)structures in the course of production thereof In particular, the transformation of linear and/or stretched allotropes back into nonlinear and/or cyclic allotropes, in particular into the alpha allotrope S₈, is prevented by the limited space. According to the invention, the active cathode material preferably consists only of sulfur, in particular in the abovementioned mixtures of sulfur allotropes, with a combination of helical phi- and/or omega-sulfur chains (helixes) with enclosed linear psi-sulfur chains being very particularly preferred.

The sulfur structures according to the invention are preferably produced by a combined heating-stretching-cooling process, in particular thermally assisted electrospinning. Here, a sulfur substrate is heated, preferably to at least 115.2° C., more preferably to more than 175° C., particularly preferably to more than 250° C., This substrate consists primarily of (technical-purity) sulfur, but can contain not only sulfur but also solvent, preferably carbon disulfide (CS₂) or dimethyl sulfoxide (C₂H₆OS), The heated substrate is provided at a suitable outlet, preferably one or more Taylor cone(s), one or more (annular) slit(s) or a (nano)lattice membrane. This is effected by means of suitable transport devices such as, for example on a laboratory scale: spraying or on an industrial scale: (piston) metering pumps, preferably in heated form as heated metering pumps. For instance, 1.0 metal piston metering pumps from, for example, the Maucher company, are industrially suitable. A particularly preferred embodiment is a heated metal piston metering pump having a hydraulic advance which conveys to a nanolattice membrane. This lattice membrane preferably consists of a ceramic material such as, particularly preferably, aluminum oxide. The membrane preferably has a pore diameter (or analogously thereto the slit has a gap width) of less than 1 micron, more 1.5 preferably less than or equal to 400 nanometers (e.g.: SmartPor180-100-A2 from Smartmembranes), At this outlet, the substrate provided is drawn to produce fibers by means of a suitable electric voltage, preferably greater than 2.5 kilovolts, more preferably greater than 25 kilovolts, particularly preferably greater than or equal to 50 kilovolts. These fibers are immediately cooled strongly, preferably from the outlet. As cooling temperature, normal room temperature (25° C.) can be adequate because of the extremely low fiber thickness in the case of appropriate material preheating, but cooling to a lower temperature can likewise be advantageous, for example by use of cold water, precooled air or cold process gases (e.g. carbon dioxide (CO₂), (hydrogen)/argon or nitrogen) or other suitable cooling media such as preferably liquid nitrogen. The important thing is that cooling occurs sufficiently quickly for the material surface (fiber surface) to solidify before the material core (fiber core) can solidify, This results in buildup of a tremendous internal pressure or internal tension in the fiber, as a result of which a phase transition of the sulfur to the desired allotropes is brought about in the fiber, or after a phase transition which had occurred due to stretching of the molecules caused by the heating and/or the applied electric voltage and the shear forces brought about thereby, this phase transition is accordingly preserved. The process is preferably carried out with exclusion of oxygen in a suitable protective atmosphere, particularly preferably nitrogen and/or hydrogen/argon (from Linde, 2% of H and 98% of Ar). The protective gas is preferably used as cooling medium which is more preferably conveyed by means of a suitable transport device (e.g. fan, compressor, pressure bottle) past the outlet of the substrate with a suitable volume flow, more preferably in a circulation process. A carbon source can also be integrated into the protective gas, for example methane (CH₄) in hydrogen/argon, in order to achieve coating of the fiber with carbon in the same process step. It is likewise possible to spray other desirable additives, in particular solvent-based or dispersed solid electrolytes directly onto the fiber in this production step by adding these additives to the cooling medium flowing past or appropriately injecting them separately at the outlet. This method of coating during the course of fiber production is not restricted to the substrate sulfur, but can be combined with all suitable substrates, for which reason this coating method is claimed here both in combination with the production according to the invention of fibers and also independently.

The precise process parameters are interdependent with one another. For example, the formation of the particularly preferred sulfur fibers preferably occurs by means of high temperature and/or high pressure, with the pressure also being able to be imparted as tension, for example by an electric or electrostatic voltage. In general, relatively low temperatures are required at a sufficiently high pressure or tension, and a relatively low through to no elevated pressure are needed at a sufficiently high temperature. For example, relatively low temperatures in the range from 120 to 200° C. combined with a relatively high compressive/tensile stress of 10 kV or more are preferred from an industrial point of view.

In particular, temperature and volume flow of the substrate determine the required temperature and the required volume flow of the cooling medium. However, the type of cooling medium and also the fiber diameter resulting from the outlet (membrane) diameter and the voltage also influences the choice of the optimum process parameters. Owing to the requirement that immediate cooling of the surface with delayed cooling of the core be achieved, it is, however, possible for a person skilled in the art to find and optimize the appropriate parameters individually as a function of the embodiment of the production plant.

It has been found that metastable sulfur chains (in particular of psi-sulfur, in particular enclosed in psi and/or omega helixes) which remain in their linear state even at room temperature and after multiple charging and discharging within a battery are produced by rapid cooling (“quenching”). In this way, a transformation back into orthorhombic alpha-sulfur can be prevented which was not to be expected, especially in view of the property described in the literature for all sulfur allotropes to transform into the alpha allotrope over time and/or as a result of charging/discharging in a battery. As an alternative to or in addition to the quenching described, the transformation back into alpha-sulfur can also be prevented by the coating described.

In addition, it has been found that the faster the cooling or quenching occurs, the more effective is the effect described. For this reason, coolants having good heat-conducting or heat-dissipating properties and/or a high mass flow of coolant are particularly preferred.

The result of the inventive production process described is a (hollow) (nano)sulfur fiber which consists predominantly of one or more of the following allotropes of sulfur: phi, mu, omega and/or psi. They preferably have a fiber diameter of less than or equal to 1 micron (μm), more preferably less than or equal to 400 nanometers (nm), particularly preferably less than or equal to 100 nanometers. The average fiber length is preferably at least 1 millimeter (mm), more preferably at least 1 cm, particularly preferably at least 10 cm.

This fiber surprisingly has semiconductor properties, which is presumably due to the continuing availability of free (unpaired) electrons at the ends of the atom chains, which are presumably able to assume an acceptor status in the band gap.

This fiber is surprisingly likewise extremely resistant to damage by chemical processes and/or volume changes which arise when the fiber is used as active composition in a battery cathode, for instance in lithiation/delithiation processes,

The fiber of the invention is preferably used as fiber mat or fiber bundle or woven fiber fabric. This is preferably effected by the fibers obtained in the above described production process and having the desired thickness being collected together with or without a specific arrangement as fiber mat, and the desired dimensions of the cathode layer then being appropriately cut out or stamped out. It is likewise possible to weave the fibers after they have been produced to give a woven fabric having the desired thickness, and then likewise cut or stamp this to produce the desired dimensions. It is important that mat, bundle or woven fabric are configured so that appropriate conduction paths from the surface into deeper layers are provided. The structure is preferably configured so that it is self-supporting. A preferred method for cutting to size is laser cutting.

These structures according to the invention surprisingly do not require any suspension/coating process (slurry coating) for further processing, in contrast to the prior art. Instead of this process, the structure (before or after cutting to size) can be impregnated directly with further additives such as conductivity additives and binders and then (likewise before or after cutting to size) applied to a conductive support provided with adhesive, preferably an aluminum foil coated with adhesive. This leads not only to a significantly improved environmental balance but also to significant cost savings,

Furthermore, due to the stability of the structure, a (quasi) solid electrolyte can be integrated into the cathode structure (“CsQSE”=Cathode-supported Quasi Solid-state Electrolyte). This can be achieved by one or more of the following methods: spray coating, electrophoretic deposition (EPD) or preferably ultrasound-assisted coating (e.g. ExactaCoat Ultrasonic Coating System from Sonotec). All these methods require subsequent drying of the electrolyte or drying-off of the dispersion medium or solvent. The electrolyte applied according to the invention is preferably fused to the sulfur structure to give a cathode-electrolyte composite structure by impulse sintering, e.g. using a flash sintering plant (e.g. PulsForge 1200 from Novacentrix). This process of coating and subsequent drying and impulse sintering of cathode structures can in principle be carried over to all fiber-based or porous cathode structures, for which reason this method is claimed here both in combination with the battery according to the invention and also independently.

Owing to the surprisingly high damage resistance of the sulfur allotropes selected, in particular in their preferred embodiment as 3D woven fabrics made of 1D fibers, the cathode layer produced in this way requires only a significantly smaller amount of binders than in the prior art customary at present. Preference is given to using less than 7% and more preferably less than 2% of binder.

Likewise, a reduction in the amount of conductive additives is possible and desirable because of the surprisingly improved conductivity, Preference is given to using less than 12% and more preferably less than 8% and very particularly preferably less than 5% of conductive additives.

These additive reductions lead to a significant cost reduction and to a significant increase in the capacity of the batteries produced in this way compared to the prior art.

On the other hand, the concentration of sulfur per unit area of the cathode layer is significantly increased compared to the prior art, which contributes to a considerable cost reduction for a given capacity made available. The sulfur concentration is preferably more than 15 mg/cm², more preferably more than 20 mg/cm², of the cathode layer area. The concentration is here measured per unit area since the cathode layer thickness can vary between 5 and 500 microns depending on the individual cell design. According to the invention, a layer thickness between 60 and 400 microns is preferred. The layer thickness in order to achieve the desired design parameters, z including the sulfur concentration per unit area, can readily be selected by a person skilled in the art on the basis of the concrete design criteria.

As a difference from the prior art, it is also not necessary for the sulfur to be chemically or physically incorporated into a macroporous, mesoporous or macroporous support structure (for instance composed of carbon or MOₓ). Instead, the structure according to the invention is able to do without such a supporting structure, which compared to the prior art means further significant advantages in respect of costs and capacity.

Altogether, these processing steps lead to a total proportion by mass of sulfur in the cathode of more than 75%, preferably from 80 to 95%, more preferably from 83 to 85%, The proportion by mass of the individual or all chosen specific sulfur allotropes) is here from 5 to 95%, preferably from 60 to 90% and most preferably 75%.

(Here too: all figures are +/− industrially normal production—and/or measurement-related standard deviations, all percentages are percent by mass (m/m) unless indicated otherwise).

Owing to its surprising stability, the structure according to the invention can remain free of alkali or alkaline earth metals during the stack/cell/battery production process. Apart from advantages in the process architecture and cost savings resulting therefrom, this also makes the present technology in respect of the cation source used (=the alkali or alkaline earth metal used) doubtful. The batteries of the invention can thus use any individual or plurality of different alkali or alkaline earth metal(s). This/these can be “monovalent”, “divalent” or “trivalent”, preferably selected from among: lithium (Li⁺), sodium (Na⁺) or potassium (K⁺) as monovalent ion, magnesium (Mg²⁺) as divalent ion or aluminum (Al⁺) as trivalent ion, very particularly preferably: lithium, sodium or magnesium. The ions selected are preferably injected as “liquid A” into the cathode during the cell or battery stack forming process. The liquid A is preferably here a solution of a salt of the metal in a suitable solvent, preferably water.

Like the cation source, a precursor medium or a support layer for an electrolyte, into which the electrolyte is then bound and is present like a solid electrolyte in bound form on the surface of the active composition (hereinafter “solid electrolyte intermediate layer”), can be injected as “liquid B” into the cathode during the course of the cell or battery stack forming process. The liquid B is preferably here an adhesive material or mixture of materials which can be dispersed or dissolved in suitable solvents or a dissolved metal oxide, more preferably an adhesive and conductive material/mixture of materials such as a conductive adhesive or a salt of a metal oxide.

Finally, the electrolyte, or two different electrolytes, is injected as “liquid C” or as two liquids C and D into the cell, e.g. an electrolyte liquid. C into the cathode and a different electrolyte liquid D into the anode, during the course of the cell or battery stack forming process. The liquids C or/and D can be selected from all suitable electrolytes known in the prior art.

Excesses of all liquids A to D can be reextracted from the cathode layers during the course of the forming process and recycled or directly reused/used further in order to save costs and to improve the environmental balance.

The procedure for carrying out the injection process per se corresponds to the prior art for such processes, and can be carried out in all embodiments normally used for such processes. The selection of the suitable process will be generally carried out so as to adapt to the existing or desired production plant.

The liquids A to D can be selected from among all suitable materials known in the prior art for: cation source, salt of the cation source, solvents, solid electrolyte intermediate layer/conductive adhesive and electrolytes. The selection will be, in particular, a decision valancing between factors such as price, capacity, cycling life, etc., since a different prioritization of these factors can be desirable depending on the intended use.

The preferred battery production method consists of the following steps: production of a “bipolar pole” consisting of a) a metallic or carbon-containing material as collector foil; b) an anode which is free of alkali and alkaline earth metals and consists of one or more layers of carbon-containing foam, preferably containing graphene and/or graphene derivatives, c) a layer of supporting collector foil on the upper side of the anode; d) a cathode consisting of an active material and a (quasi) solid electrolyte which shares the same collector foil c) with the anode b); and subsequent packing of one or more units a) to d) into a frame or a housing, preferably composed of e) a polymer material, preferably a polyvinyl chloride, polyethylene, polypropylene, polyoxymethylene, polyamide, fluoro polymer, styrene polymer, polyurethane, polycarbonate and/or a combination thereof, to give a final battery. The preferred battery contains the inventive sulfur allotrope in the cathode d), but this manufacturing method is also suitable for a wide range of other materials and it is also claimed independently as such.

Preference is likewise given to a production method in which a battery precursor cell which is free of alkali and alkaline earth metals is firstly produced and then liquid sources of alkali metal ions are pumped into this precursor cell, Each cell chamber is preferably supplied separately with the alkali metal ion source, with the liquid circulating through suitable inlet and outlet ports until the suitable cell parameters have been attained. For this purpose, preference is given to one or more of the following parameters being measured on the respective bipolar poles and optionally being influenced/varied in a suitable way: voltage, temperature, pressure, impedance, molarity/concentration of the liquid A (preferably both at the inlet and at the outlet) and also flow rates of the liquids A to D. Since this manufacturing method is not restricted to the inventive battery but is suitable for many battery types, it is claimed both in combination with the inventive battery and also independently.

### EXAMPLES

Sulfur fibers were produced using the materials and process parameters indicated below:

Sulfur: procured from Merck

Temperature: 200° C.

Transport device: transport cylinder

Outlet: perforated membrane or multi-nozzle

Volume flow: about 10 g/minute

Pressure: atmospheric pressure—pure pushing along of the material

Voltage: 30 KV

Cooling medium/protective

gas: nitrogen at room temperature

The production apparatus consists of a metal cylinder 1 which has a perforated membrane as outlet at one end and at the other end is closed by a tightly sealing likewise cylindrical transport device. Heating elements are wound around the metal cylinder 1 so as to allow heating of the cylinder. At the end corresponding to the transport unit, the metal cylinder 1 can be opened in order to be filled with the production medium, in this case sulfur. The end with the perforated membrane is connected in an airtight manner to a further cylinder 2. The cylinder 2 is preferably made of metal and coated on the inside with polymer (e.g. PTFE) and has a diameter of from 10 to 20 cm. This cylinder 2 is closed in an airtight manner at the bottom and the top and can be flushed with protective gas or a cooling medium. For this purpose, the upper end of the cylinder is provided with an inlet and the lower end of the cylinder is provided with an outlet for the protective gas or cooling medium. The lower end/the outlet additionally contains a suitable trapping device for solids, e.g. a filter. A high voltage source is present at the end of the cylinder 2 opposite the outlet of the metal cylinder 1. This high voltage source is insulated from the cylinder wall.

The metal cylinder 1 is filled with pulverulent sulfur and heated to 200° C., resulting in the sulfur melting. After a temperature of 200° C. has been reached in the interior of the metal cylinder 1, a voltage of 30 kV is applied by means of the high voltage source in the cylinder 2. This voltage leads to the liquid sulfur being drawn out of the outlet opening into the cylinder 2. There, it is immediately cooled strongly by nitrogen flowing through, and the fiber falls as fragment to the outlet end or is conveyed to there by the cooling medium flowing past.

A yield of about 10 g/minute can be produced by means of the apparatus described. The sulfur material produced in this way is used as active cathode material in a battery cell according to the invention.

The following table gives an overview of the main differences between a battery cell according to the prior art and the battery cell according to the invention.

TABLE 1

| | |
|---|---|
| | Fiber-based sulfur- |
| State of the art Li—S | lithium battery according |
| battery/prior art | to the invention |

(Part 14 of 2)

| | | |
|---|---|---|
| Construction | Monopolar pouch cell | Bipolar octagonal cell |
| Production method for | Slurry coating - solvent- | Self-supporting woven |
| cathodes | based | fabric-solvent-free |
| Drying method for | IR drying | No drying necessary - |
| cathodes | | “pick and place” |
| | | used for the woven fabric |
| Average sulfur loading | 5 mg/cm² | >20 mg/cm² |
| Method for sulfur | Infiltration in porous | No extra inclusion |
| inclusion | support structures | (infiltration) necessary - |
| | (micro-meso-macro | direct production of the |
| | porous) | sulfur fibers |
| Average porosity | ca. 38% (v/v) | <25% (v/v) |
| (volume) of the cathode | | |
| after pressing | | |
| Method for compressing | Rolling/pressing | Only cutting-out/ |
| the electrodes | (calendaring) at 85° C. | stamping. Optionally |
| | | simple pressing at room |
| | | temperature |
| Type of collector foil | Carbon-coated aluminum | Aluminum foil pretreated |
| (cathode) | foil | with adhesive |
| Method for compensating | Internal porosity and | In the case of an intact |
| for volume changes | binder excess | fiber according to the |
| | | invention, only small |
| | | volume change (<3% |
| | | v/v) |
| Binder content | ca. 10% | <=6% |

(Part 2 of 2)

| | | |
|---|---|---|
| Total content of | ca. 18% | <=10% |
| conductive additives | | |
| Type of electron | Particle-to-particle | Entire fiber-based 3D |
| conduction in the cathode | interaction | e⁻ conduction path |
| (e⁻ transfer) | | through 1D fibers which |
| | | project into another/are |
| | | conductively connected |
| Gravimetric capacity | 940 mAh/g @ C/2 | 1420 mAh/g @ C/2 (80% |
| (sulfur cathode) | | DoD) |
| Life as a function of the | 5 mg/cm² of sulfur | >18 mg/cm² of sulfur |
| sulfur concentration and | 200 × @ C/10 | 380 × @ 1C (prototypes |
| C rate | | in ongoing test on |
| | | potentiostat) |
| Production method for | Lithium foil | Carbon-based support |
| anodes | | structure for lithium |
| Lithium excess | 120% | 20% |
| Method for loss | Significant lithium | Precise method for |
| compensation | excess | adding the lithium |
| | | source; additionally |
| | | small lithium excess |
| Method for reducing | Thin layer on separator | Use of (quasi) solid |
| formation of polysulfites | | electrolyte in the cathode |
| Degree of order of the | Disordered, unoriented, | 80% oriented 1D fiber |
| electrode porosity | high degree of | structure, conductively |
| | entanglement | connected fibers, low |
| | | degree of entanglement, |
| | | improved conduction |
| | | paths for cations⁺ |

(All values +/− industrially normal production—and/or measurement-related standard deviations. All percentages are percent by mass (m/m) unless specifically indicated).

1. An alkali metal ion-sulfur battery which contains sulfur allotropes having a chain-like arrangement, preferably mu, omega or psi allotropes, most preferably psi allotropes.

2. The alkali metal ion-sulfur battery as claimed in claim 1, wherein the proportion by mass of the individual or all selected allotropes in the cathode is from 5 to 95%, preferably from 60 to 90%, most preferably from 73 to 77%.

3. The alkali metal ion-sulfur battery as claimed in claim 1, wherein the sulfur material is present as a one-dimensional structure, preferably as fibers, hollow fibers, rods or tubes, most preferably as hollow fibers.

4. The alkali metal ion-sulfur battery containing phi allotropes of sulfur in the cathode.

5. The alkali metal ion-sulfur battery as claimed in claim 4, wherein the proportion by mass of the phi allotrope is from 5 to 30%, preferably from 10 to 15%.

6. The alkali metal ion-sulfur battery as claimed in claim 1, wherein the total proportion by Mass of sulfur in the cathode is more than 75%, preferably from 80 to 95%, more preferably from 83 to 85%.

7. The alkali metal ion-sulfur battery as claimed in claim 1, wherein the cathode contains a self-supporting structure formed by 1D sulfur structures such as fibers, rods or hollow fibers which form a 3D sulfur structure such as a mat, a woven fabric or the like.

8. The alkali metal ion-sulfur battery as claimed in claim 1, wherein the proportion by mass of sulfur per unit area of the active composition is at least 5 mg/cm², more preferably at least 20 mg/cm².

9. The alkali metal ion-sulfur battery as claimed in claim 1, wherein a plurality of electrodes are processed so as to be stacked in a bipolar design.

10. The alkali metal ion-sulfur battery as claimed in claim 1, wherein the cathode consists of a self-supporting 3D structure which is adhesively joined to a collector foil.

11. The alkali metal ion-sulfur battery as claimed in claim 1, wherein a metal oxide coating is provided in situ on the surface of the 1 D structures.

12. An alkali metal ion-sulfur battery, wherein the cathode or/and anode is free of alkali and alkaline earth metals during the stack and/or cell and/or battery production process.

13. The alkali metal ion-sulfur battery as claimed in claim 12, wherein a monovalent, divalent or trivalent cation source, preferably Li⁺ or Na⁺ as monovalent source, Mg²⁺ as divalent source or Al³⁺ as trivalent source, is injected as “liquid A” into the cells or the battery during the battery production process.

14. The alkali metal ion-sulfur battery as claimed in claim 13, wherein a precursor medium for a solid electrolyte is also injected as “liquid B” into the cells or the battery during the battery production process.

15. The alkali metal ion-sulfur battery as claimed in claim 14, wherein the main electrolyte is injected as “liquid C” into the cells or the battery during the battery production process.

16. The alkali metal ion-sulfur battery as claimed in claim 14, wherein two different electrolytes are injected as “liquid C” and “liquid D” into the cells or the battery during the battery production process, with liquid C being injected exclusively on the cathode side and liquid D being injected exclusively on the anode side.

17-27. (canceled)
